(19) United States
(12) Patent Application Publication
(10) Pub. No.: US 2002/0001078 A1
(43) Pub. Date: Jan. 3, 2002

(54) Optical measuring arrangement, in particular for quality control in continuous processes

(76) Inventors: Juergen Gobel, Jena (DE); Werner Hoyme, Jena (DE); Martin Goetz, Jena (DE); Wilhelm Schebesta, Jena (DE)

Correspondence Address: Gerald H. Kiel, Esq., REED SMITH LLP, 375 Park Avenue, New York, NY, 10152-1799, US

(21) Appl. No.: 09/797,154

(22) Filed: Mar. 1, 2001

(30) Foreign Application Priority Data
Mar. 2, 2000 (DE) 100 10 213.1

(51) Int. Cl. G01J 3/42

(52) U.S. Cl. 356/326; 250/339.05; 250/339.07

(57) ABSTRACT

An optical measuring arrangement, particularly for quality control in continuous material flow processes, comprising a measuring head which is arranged immediately adjacent to a measurement object, a measurement light source which is held at the measuring head for illuminating a measurement spot on the measurement object, a measurement light reception device, at least one spectrometer which is optically coupled with the measurement light reception device via a light-conducting device, wherein the spectrometer and the light-conducting device are received in the measuring head, and a signal processing device which is likewise received in the measuring head. This results in a compact arrangement for reflection measurement which is easy to assemble and which, beyond this, supplies very accurate measurement results. Further, a measuring arrangement operating on the principle of spectroscopy is suggested for transmission measurement. The disclosure further relates to a combined reflection and transmission measurement device which carries out both measuring processes simultaneously.

### BACKGROUND OF THE INVENTION

a) Field of the Invention

The invention is directed to an optical measuring arrangement for determining properties of measurement objects. It is particularly suited for quality control in a continuous flow or continuous movement of measurement objects.

b) Description of the Related Art

There are measuring arrangements operating on the principle of spectroscopy which are known from prior art by which the reflection factor or transmission factor of measurement objects can be detected. Based on the detected measurement spectrum, information can be gathered about optical and non-optical properties of the measurement objects which can be used in turn to make judgments about the examined measurement objects.

For example, sheets or slabs of material can be monitored for dimensional stability and quality parameters by spectroscopic examination. Monitoring of non-solid material flows is also possible.

In this connection, it is known from the prior art to detect the reflection behavior of the measurement objects in order to obtain judgment criteria therefrom for quality control. With transparent measurement objects, the transparency of the measurement object can be determined spectroscopically by measuring transmission.

Conventional measuring arrangements for measuring reflection or transmission generally use an optical measuring head arranged in the immediate vicinity of the measurement object. This measuring head comprises a measurement light source for illuminating a measurement spot on the measurement object. Further, a receiver is provided directly adjacent to the measurement object for detecting light in the area of the measurement spot. In case of reflection measurement, the receiver is located on the side of the measurement light source and detects light reflected by the measurement object. In the case of transmission measurement, on the other hand, the receiver is arranged on the opposite side of the measurement object in relation to the measurement spot and detects light that penetrates through the measurement object. In order to evaluate the detected light of the measurement spot, a spectrometer is used which is set up remote of the measurement object. The light detected by the receiver is directed to the spectrometer via a comparatively long path on the order of about 20 meters by means of a light guide comprising a plurality of individual fibers. The length of the transmission path results in influences which impair the physical values of the measurement light and, therefore, the quality of the information to be determined. For example, transmission changes in the light guide can occur due to mechanical or thermal influences.

Further, it must be taken into account that the optical measuring head must be movable along or next to the measurement object so that wider material webs or flows of material can also be examined. For this purpose, the measuring head is arranged on a traverse or crosspiece arrangement which is movable relative to the measurement object. In order to prevent mechanical damage to the light guide in such cases, technical precautions against premature breakage are required. Therefore, the light guide must be laid with special care. Further, apart from optical and mechanical impediments, the known optical measuring arrangement is relatively complicated to install because the measuring head can only be coupled with the spectrometer in situ after careful laying of the light guide. Therefore, in order to achieve reproducible results, the arrangement must be adjusted to a reference state in situ. This adjustment is necessary with every reinstallation of the known arrangements.

### OBJECT AND SUMMARY OF THE INVENTION

Therefore, it is the primary object of the invention to further develop an optical measuring arrangement operating on the principle of spectroscopy in such a way that it is suitable for quality control of measurement objects flowing and/or moving past the measuring arrangement continuously and which can be assembled and disassembled in a simple manner.

This object is met by an optical measuring arrangement of the type mentioned above comprising a measuring head which is arranged immediately adjacent to a measurement object, a measurement light source which is held at the measuring head for illuminating a measurement spot on the measurement object, a measurement light receiver provided at the measuring head for detecting light from the area of the measurement spot, at least one spectrometer which is optically coupled with the measurement light receiver via a light-conducting device, wherein the spectrometer and the light-conducting device are received in the measuring head, and a signal processing device which is likewise received in the measuring head for processing the output signals of the at least one spectrometer.

The measuring arrangement according to the invention can be assembled simply and quickly near the measurement object to be examined. In this connection, the alignment or adjustment for matching the measurement light receiver to the spectrometer or spectrometers can be carried out already in the manufacturing plant, so that, with the exception of the adjustments of the measuring head in relation to the measurement object which are required in any case, no additional alignment steps are needed for in-situ assembly. In this way, first-time assembly as well as reassembly of the measuring arrangement are substantially simplified.

Further, arranging all components in a measuring head or a compact measuring head results in the shortest connection paths between the measurement light receiver and the spectrometer or spectrometers. This not only economizes on material and saves costs with respect to the use of light guide material, but the measurement light intensity which is dependent on the length of the light-conducting device can also be improved. Further, transmission changes are reduced and their disruptive influence on measurements is reduced. Further, a mechanical overstressing of the sensitive light-conducting devices can be avoided.

The term “measuring head” includes both open and closed housings as well as stage-like or platform-like holding constructions which are carried by all of the above-mentioned component assemblies.

In an advantageous construction of the invention, two spectrometers which cover adjoining wavelength ranges are received in the measuring head, wherein both spectrometers cooperate with the same measurement light receiver and are optically coupled therewith via a Y-light guide. The measuring arrangement in its entirety preferably covers a total wavelength range of approximately 350 nm to 2500 nm. The VIS range (visible light) preferably supplies optical information, for example about color characteristics and reflective and antireflective coating, whereas the NIR range (near infrared range) supplies information about concentrations of constituents or component parts of measurement objects. Preferably, one spectrometer is used for the NIR range and another spectrometer is used for the VIS range and UV range. As a result of this wavelength-oriented division of spectrometers, these spectrometers can be built particularly compactly and can be accommodated jointly in a measuring head or housing.

The use of the Y-light guide allows simultaneous measurement over the entire, broad wavelength range, wherein the quality of the measurements is enhanced by arranging the spectrometer directly adjacent to the measurement light receiver. The length of the Y-shaped light guides is preferably less than 20 cm.

A data interface is preferably provided at the measuring head for connecting the optical measuring arrangement to an external computer and/or an external display device. The latter may be accommodated, for example, in a control room remote from the measurement location. The connection is made via an electric line or also via an infrared remote connection.

In another advantageous construction of the invention, an integrating or photometric sphere with an opening directed to the measurement spot is provided at the measuring head, wherein the measurement light source is integrated in the photometric sphere in order to make possible a diffuse, indirect illumination of the measurement spot. The measurement light receiver which is likewise provided at the photometric sphere is directed to the measurement spot through the opening of the photometric sphere. The component assemblies required for generating the measurement light and for receiving the measurement signals to be evaluated can accordingly be integrated in a module which can be used, for example, for different housing types of a device series.

In order to compensate for changes in intensity of the measurement light source and for systematic measurement errors, particularly with the use of a photometric sphere, there is provided in the measuring head, for every spectrometer, a second identical spectrometer in which the light of a reference surface is faded in synchronous to the operation of the first spectrometer. When two spectrometers are used for the wavelength ranges mentioned above, a short Y-light guide is used again. The relevance of the conclusions drawn from the measurement signals can be further improved by forming a compensation signal between the respective identical spectrometers.

The reference surface is preferably located at an inner wall portion of the photometric sphere whose light is detected through a reference light receiver which is likewise provided at the photometric sphere. In order to prevent falsification of measurements, the reference light receiver is advisably not struck directly by the measurement light.

In another advantageous construction which enables measurement of transmission in addition to the measurement of reflection, the optical measuring arrangement comprises a second measuring head which is arranged directly adjacent to the measurement object in a defined position and which is located diametrically opposite to the first measurement head in relation to the measurement spot and measurement object. Provided at the second measuring head are a measurement light receiver for detecting light from the area of the measurement spot and, further, at least one spectrometer which is optically coupled with the measurement light receiver via a light-conducting device and, finally, a signal processing device for processing the output signals of the at least one spectrometer of the second measuring head.

This arrangement allows measurement of reflection and transmission simultaneously at the same measurement location, so that a high measuring speed can be realized. The measuring time for the evaluation of a measurement location can be well under one second. Two spectrometers which cover adjoining wavelength regions are preferably received in the second measuring head, wherein both spectrometers cooperate with the same measurement light receiver of the second measuring head and are optically coupled therewith via a Y-light guide. As was already mentioned in connection with the first measuring head, a broad wavelength range of, e.g., 350 nm to 2500 nm can be covered simultaneously in this way by a single measurement, so that the measuring efficiency can be further improved.

To compensate for changes in intensity of the measurement light source and systematic errors which may possibly occur, signal compensation can also be carried out in transmission measurement. The same compensation signal as that used in reflection measurement is used for this purpose.

For signal compensation, it is advantageous when a data interface is likewise provided at the second measuring head for connecting the optical measuring arrangement with an external computer and/or an external display device. The data transfer required for signal compensation can then be carried out via the external computer, so that there is no need for a connection line between the individual measuring heads. Through the use of two compensation spectrometers in the first measuring head, the expenditure on apparatus for additional compensation in transmission measurement can be kept low. The compensated signals can be determined in every measuring head as well as in the external computer.

The object of the invention is also met through an optical measuring arrangement which is designed exclusively for transmission measurement. For this purpose, this measuring arrangement comprises a first measuring head which can be arranged in a defined position directly adjacent to a measurement object, a measurement light source which is held at the first measuring head for illuminating a measurement spot on the measurement object, a second measuring head which can be arranged in defined position directly adjacent to the measurement object and which is located diametrically opposite to the first measuring head in relation to the measurement spot on the other side of the measurement object, a measurement light receiver provided at the second measuring head for detecting light from the area of the measurement spot, at least one spectrometer which is optically coupled with the measurement light receiver via a light-conducting device, wherein the spectrometer and the light-conducting device are received in the second measuring head, and a signal processing device for processing the output signals of the at least one spectrometer of the second measuring head.

This results in the advantages already mentioned above in connection with reflection measurement.

As in the former case, also with a measuring arrangement designed for transmission measurement, two spectrometers which cover adjoining wavelength regions are provided in the second measuring head, wherein both spectrometers cooperate with the same measurement light receiver of the second measuring head and are optically coupled therewith via a Y-light guide. Accordingly, a broad wavelength range corresponding to the UV, VIS and IR ranges, for example, the entire wavelength range from about 350 nm to 2500 nm, can also be covered with transmission measurement by a single measuring process.

In another advantageous construction, for every spectrometer in the second measuring head there is a second, identical spectrometer provided in the first measuring head in which the light of a reference surface is faded in synchronous to the operation of the first spectrometer. In this way, changes in intensity of the measurement light sources and systematic errors during measurement can be compensated.

Further, the photometric sphere mentioned above can be used in the first measuring head, wherein, when measuring transmission exclusively, a measurement light receiver is not required and can accordingly be dispensed with. When using only one photometric sphere in a device series, a receiving opening provided at a corresponding location for the measurement light receiver can be left unoccupied. The corresponding opening is preferably closed by a cap.

A data interface is provided at each of the two measuring heads for communicating with an external computer and/or an external display device, wherein the data transmission is carried out via an electric line or via an infrared remote connection. Insofar as no spectrometer is used for signal compensation in the first measuring head or housing, the data interface at the measuring head can also be dispensed with.

For further simplification of the measuring arrangement, the light-conducting device is advantageously formed of light-conducting fibers whose free ends toward the measurement object simultaneously form the measurement light receiver.

A particularly compact construction of the measuring heads and housing can be achieved when the utilized spectrometers are constructed as miniature spectrometers with diode line receivers.

In another advantageous construction, the measurement light source can be switched on and off for the purpose of forming signals. Accordingly, in contrast to the use of a constant light source, moving shutters which are required for dark measurement can be avoided, so that the measuring arrangement is further simplified. Moreover, shaking resulting from the movement of the shutters is also avoided, so that the intervals between individual measurements can be kept very short.

The invention is described more fully in the following with reference to the drawings.

### BRIEF DESCRIPTION OF THE DRAWINGS

In the drawings:

FIG. 1 shows a first embodiment example of a spectroscopic measuring arrangement for reflection measurement;

FIG. 2 shows a second embodiment example of a spectroscopic measuring arrangement for reflection measurement in which signal compensation is carried out;

FIG. 3 shows a third embodiment example of a spectroscopic measuring arrangement which allows simultaneous reflection measurement and transmission measurement in a partial spectral range (UV or VIS or NIR) with compensation; and

FIG. 4 shows a fourth embodiment example of a spectroscopic measuring arrangement for transmission measurement in the UV, VIS and NIR spectral ranges with signal compensation.

### DESCRIPTION OF THE PREFERRED EMBODIMENTS

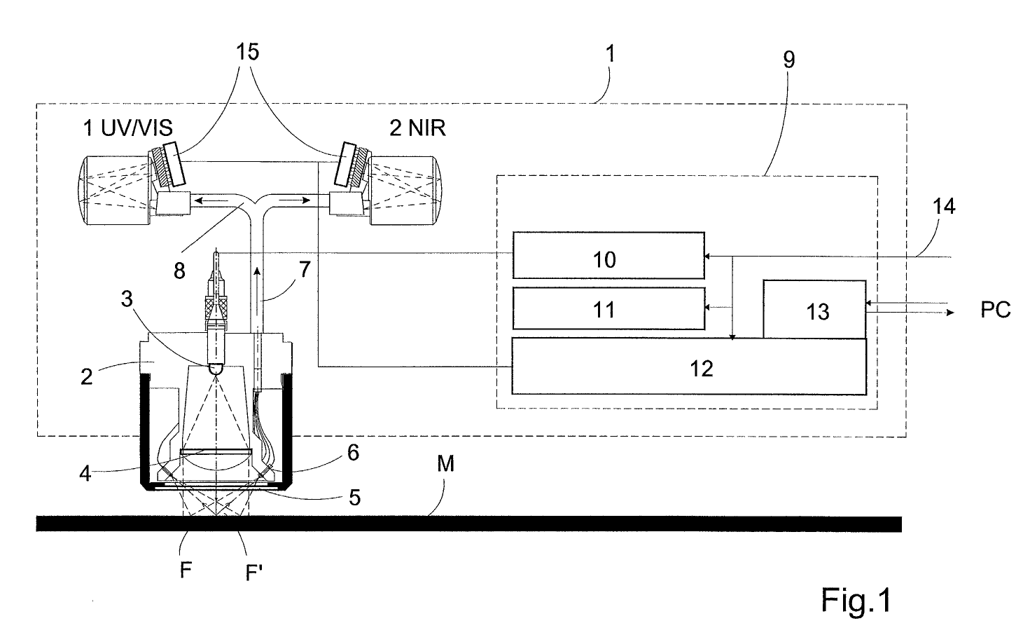

The first embodiment example in FIG. 1 shows a spectroscopic measuring arrangement for reflection measurement with a measuring head 1 in the form of a compact housing which can be arranged at a defined distance in front of or over a measurement object M. In the present embodiment example, the measuring arrangement is used for quality control with a sheet or slab of material. However, it can also be used for other solid measurement objects as well as for flows of material without solid shape.

The measuring head 1 is preferably fastened to a crosspiece which is movable transverse to the measurement object M or material web, so that determination of properties can be carried out over the entire width of the material web, material slab or material flow, since the part of the measurement spot F used by the measuring arrangement is generally appreciably smaller than its total extent.

A measuring unit 2 comprising a measurement light source 3 is provided in the measuring head 1. This measuring head 1 need not necessarily be closed on all sides; it can also be a holding stage or platform, for instance. In the present embodiment example, a halogen lamp is used as measurement light source 3. However, it is also possible to use a deuterium lamp in this location, or a halogen lamp together with a deuterium lamp.

As can be see from FIG. 1, the measuring unit 2 also has a condenser lens 4 for vertical projection of the measurement light of the measurement light source 3 on the measurement object M. Use of the lens 4 results in a uniform illumination of the measurement spot F on the measurement object M. The measuring unit 2 is closed at its end directed to the measurement object M by a protective glass 5 which is transparent to light.

A measurement light receiver 6 formed by free ends of single-mode light-conducting fibers arranged in radially symmetric manner about the center axis of the measuring unit 2 is provided for detecting the light reflected by the measurement object M in the area of the measurement spot F. The free ends of the optical mono-fibers are inclined at an angle of 45E to the surface of the measurement object M. The distance of the individual ends from the measurement spot F is selected in such a way that the observation sphere of every individual optical mono-fiber detects the same portion F′ of the measurement spot F. This portion F′ is somewhat smaller than the illuminated measurement spot F, so that the sensitivity of the arrangement to variations in the distance of the measuring unit 2 from the measurement object M can be sharply reduced. Deviations from the spatial uniformity of the reflected light caused by the measurement object are compensated by the arrangement.

The optical mono-fibers are combined to form a bundle and are coupled to a Y-light guide 8 at a coupling location in the area of a rear support of the measuring unit 2. The measurement light detected by the measurement light receiver 6 is distributed into two spectrometers SP1 and SP2 by means of this Y-light guide 8. These two spectrometers are constructed as miniature spectrometers with a diode line receiver 15. A spectrometer SP1 covers the UV range and the range of visible light, while the second spectrometer SP2 in the long-wave range adjoins the wavelength range of the first spectrometer SP1 and, consequently, detects the near infrared range. The two spectrometers SP1 and SP2 together cover a wavelength range from 350 nm to 2500 nm.

Proportional electric signals are formed in the spectrometers SP1, SP2 for different wavelength ranges and are conveyed to an electronics unit 9 contained in the measuring head 1. A signal processing device 12 in which the signals obtained from the spectrometers SP1 and SP2 are processed and, where appropriate, also digitized, is provided in this electronics unit 9. Further, an interface 13 is provided in the electronics unit 9 for connecting the measuring arrangement with an external computer and/or an external display device. The transmission of the processed signals can be carried out via a suitable signal line or also by infrared remote transmission. The external computer is set up, for example, in a control room remote from the measurement location. Additional evaluating jobs can be carried out in the external computer. Insofar as only instantaneous values for the measurement object M to be examined are required, a display device can also suffice for showing the measurement results. The required evaluation operations are then carried out in the signal processing device 12 at the measurement location itself.

The electronics unit 9 further comprises a device for stabilized voltage supply 10 for the measurement light source 3 and a connection to a current supply 14. The control of the individual components and the switching on and switching off of the measurement light source 3 for carrying out a measurement is controlled by a microprocessor 11 which is likewise contained in the electronics unit 9.

The measurement process for obtaining spectral signals when measuring reflection without a compensation signal is carried out by determining the following signals under microprocessor control.

With the lamp switched off, a dark measurement is carried out synchronously in the two spectrometers SP1 and SP2:

S_{D1}; S_{D2}.

With the lamp switched on and with white standard introduced, a bright measurement is carried out synchronously in the two spectrometers SP1 and SP2:

S_{W1}; S_{W2}.

With the lamp switched on and, depending on the demands of the method, without a specimen or with a black specimen, another bright measurement is carried out synchronously in both spectrometers:

S_{S1}; S_{S2}.

Further, with the lamp switched on, a bright measurement is carried out synchronously in both spectrometers SP1 and SP2 on a measurement specimen:

S_{P1}; S_{P2}.

The measurement results are achieved in the manner discussed in the following.

First, a dark correction is carried out for each spectrometer by subtraction from the spectral signals of the bright measurement and the dark measurement which preceded it as immediately as possible, wherein the same specimen is applied with both measurements:

S_{korr,i}=Sᵢ−S_{Di}.

The index i describes the number of the spectrometer under consideration as well as the common specimen type (W, S, P).

The dark-corrected signals of the measurement specimen and white specimen are decreased by the dark-corrected signals of the black specimen and the measurement signal difference is divided by the white signal difference. The quotient is the reflection factor of the measurement specimen in relation to that of the white specimen:

$${R}_{1} = \frac{{S}_{korrP1} - {S}_{korrS1}}{{S}_{korrW1} - {S}_{korrS1}} ; {R}_{2} = \frac{{S}_{korrP2} - {S}_{korrS2}}{{S}_{korrW2} - {S}_{korrS2}}$$

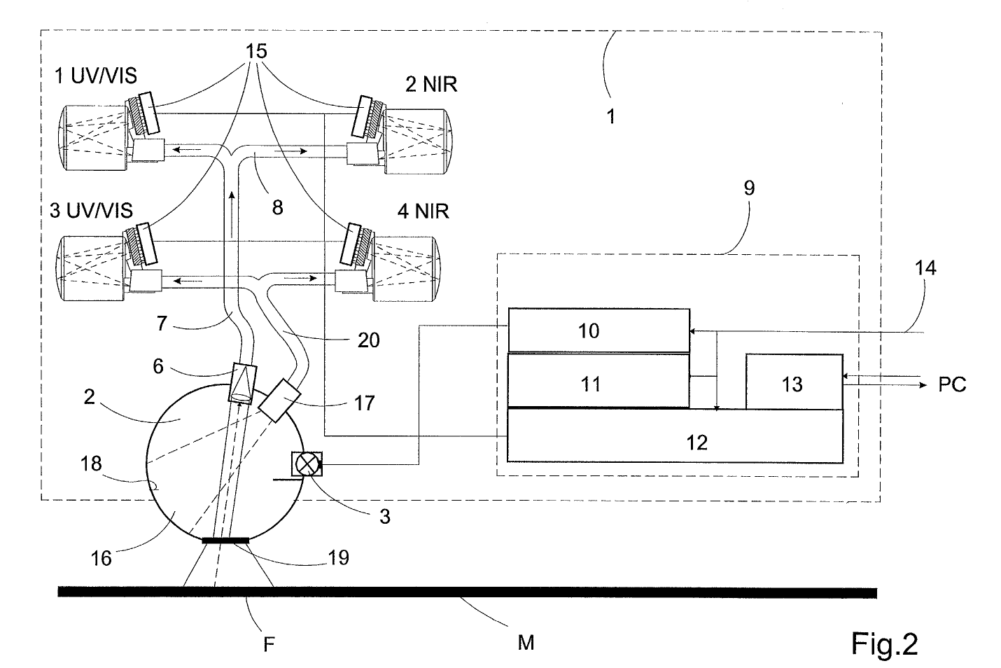

The second embodiment example in FIG. 2 shows another optical measuring arrangement working on the principle of spectroscopy. As in the first embodiment example, it is used for measuring reflection and differs from the first embodiment example primarily through the construction of the measuring unit 2 and the additional use of two further spectrometers SP3 and SP4 to compensate for light intensity fluctuations of the measurement light source 3 and systematic errors in measurement.

The measuring unit 2 according to the second embodiment example is constructed as a photometric sphere 16 which is located at a defined distance from the measurement object M with an opening 19 directed to the object M. A measurement light source 3 in the form of a halogen lamp is integrated in the photometric sphere 16 and is arranged such that a uniformly diffuse illumination of the measurement spot F on the measurement object M is carried out through the opening 19. Further, a measurement light receiver 6 is arranged at the photometric sphere 16 with a view to the measurement spot F through the opening 19. The reception direction of the measurement light receiver 6 is preferably adjusted at an angle of 8E relative to the normal line on the measurement object M. The measurement light captured in the measurement light receiver 6 is guided by a Y-light guide 7 simultaneously into two miniature spectrometers SP1 and SP2, each having a diode line receiver 15 for obtaining measurement signals. The arrangement and division according to spectral ranges corresponds to that in the first embodiment example.

In addition to the measurement light receiver 6, another reception device 17 which sees neither the measurement light source 3 nor the measurement object M directly is provided at the photometric sphere 16. This additional reception device 17 is instead directed to a reference surface 18 at the inner wall of the photometric sphere 16. The reference light detected by the reception device 17 is conveyed again via a Y-light guide 20 to two spectrometers SP3 and SP4. The spectrometers SP3 and SP4 correspond to spectrometers SP1 and SP2 with respect to design, so that the signals obtained at spectrometer SP3 are used to compensate the signals obtained from spectrometer SP1, and the signals obtained from spectrometer SP4 are used to compensate the signals obtained from spectrometer SP2. All of the signals obtained at the spectrometers are transmitted to an electronics unit 9 which is constructed in the same manner as in the first embodiment example. The measurement results can be obtained in the external computer mentioned above. However, it is also possible to transfer these operations to the signal processing device 12 of the electronics unit 9.

The following measurements are carried out for obtaining signals in a reflection measurement with formation of compensation signals:

With the lamp switched off, a dark measurement is carried out synchronously in the two spectrometers SP1 and SP2 and in the two spectrometers SP3 and SP4:

S_{D1}; S_{D2}; S_{D3}; S_{D4}.

With the lamp switched on and white specimen introduced, another bright measurement is carried out in all four spectrometers:

S_{W1}; S_{W2}; S_{W3}; S_{W4}.

With the lamp switched on and depending on the demands of the method without specimen (air) or with black specimen, the bright measurement is carried out in all four spectrometers:

S_{S1}; S_{S2}; S_{S3}; S_{S4}.

Finally, with the lamp switched on a synchronous bright measurement is carried out in all four spectrometers with a measurement specimen:

S_{P1}; S_{P2}; S_{P3}; S_{P4}.

The measurement results are reached as follows:

First, a dark correction is carried out by subtracting from the spectral signals of the bright measurement and the dark measurement which precedes the latter as closely as possible for each spectrometer and the same specimen:

S_{korr,i}=Sᵢ−S_{Di}.

The index i again describes the spectrometer number and the common specimen type (W; P; S).

The dark-corrected measurement signals of spectrometer SP1 are standardized on the dark-corrected compensation signals of spectrometer SP3 and the dark-corrected measurement signals of spectrometer SP2 are standardized on the dark-corrected compensation signals of SP4. These are measurements with an individual specimen:

$${Q}_{P1} = \frac{{S}_{korr , P1}}{{S}_{korr , P3}} ; {Q}_{P2} = \frac{{S}_{korr , P2}}{{S}_{korr , P4}} ; {Q}_{W1} = \frac{{S}_{korr , W1}}{{S}_{korr , W3}} ; {Q}_{W2} = \frac{{S}_{korr , W2}}{{S}_{korr , W4}} ; {Q}_{S1} = \frac{{S}_{korr , S1}}{{S}_{korr , S3}} ; {Q}_{S2} = \frac{{S}_{korr , S2}}{{S}_{korr , S4}}$$

The reflection factor for each partial area is calculated from the quotients of The spectrometers associated with each spectral partial area:

$${R}_{1} = \frac{{Q}_{P1} - {Q}_{S1}}{{Q}_{W1} - {Q}_{S1}} ; {R}_{2} = \frac{{Q}_{P2} - {Q}_{S2}}{{Q}_{W2} - {Q}_{S2}}$$

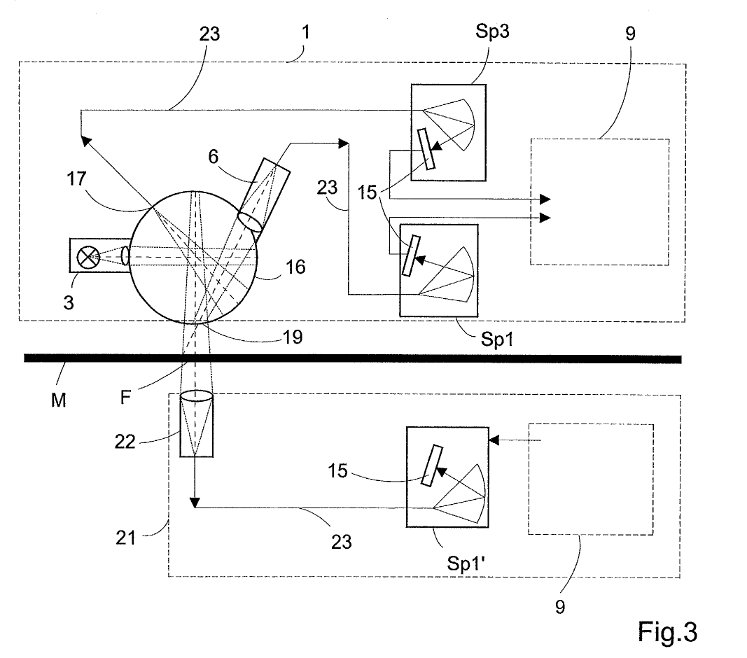

The third embodiment example in FIG. 3 shows a spectroscopic measurement device for simultaneous measurement of reflection and transmission having two reception devices located opposite one another with reference to a measurement spot F at the measurement object, wherein one is used for reflection measurement and the other is used for transmission measurement. A measuring arrangement such as that described in the first or second embodiment example can be used for measuring reflection, wherein two spectrometers are used for long-range measurement. This is also possible, in principle, in the third embodiment example. However, for the sake of simplicity, an individual spectrometer for reflection measurement and an individual spectrometer for transmission measurement are used in the description. A third spectrometer is provided for compensation purposes.

The measuring arrangement comprises a first measuring head 1 with a photometric sphere 16 whose opening 18 can be arranged at a defined distance from a measurement spot F at a measurement object. A measurement light source 3 is arranged in the photometric sphere 16 for diffuse illumination of the measurement spot F. Depending on the required spectral range, a halogen lamp, xenon lamp or deuterium lamp can be used as measurement light source 3 and is switched on in phases for measurement purposes. A dark measurement is carried out in the intervals; this is needed for compensation of an unavoidable electronic offset and possible external light influences. In the same way, a xenon flash lamp can be used in the third embodiment example as in the two embodiment examples described previously. In both cases, a mechanical shutter is no longer required for the dark measurement.

As in the second embodiment example, a measurement light receiver 6 and a reception device 17 are again provided at the wall of the photometric sphere 16 and each is connected with a spectrometer SP1 and SP3, respectively, via its own light-conducting device 23. In order to achieve high quality signals, the light-conducting devices 23 are again kept short, preferably below a length of 20 cm. In this case, again, miniature spectrometers with diode line receivers 15 are used as spectrometers SP1, SP3 and, like the photometric sphere 16 and light-conducting devices 23, are arranged in the first measuring head 1.

Further, for controlling the measurement light source 3 and for signal processing and for connecting with an external computer or an external display device 1, an electronics unit 9 whose construction corresponds to that in the second embodiment example is arranged in the measuring head 1.

For transmission measurements, a second measuring head 21 is provided which has another measurement light receiver 22 directed to the measurement spot F. During a measurement process, this measurement light receiver 22 is located on the side of the measurement spot F opposite the opening 19 of the photometric sphere 16. The measurement light of the measurement light receiver 22 of the second measuring head 21 is guided into a separate spectrometer SP1′ with diode line receiver 15 arranged in the second measuring head 21, the optical coupling being effected via a light-conducting device 23. An electronics unit 9 is provided in the second measuring head 21. In addition to a signal processing device and an interface for data transmission to an external computer and/or external display device, this electronics unit 9 also has a microprocessor for controlling communication with the external computer or the external display device (not shown in detail).

The two measuring heads 1 and 21 are aligned relative to one another in a stationary frame or are movable synchronously in a double-crosspiece. Because of the miniaturization of the spectrometers, the mass of the individual measuring heads is small, so that high measuring dynamics are ensured with small acceleration forces.

In the present embodiment example, the external computer which was already mentioned controls the cooperation of the two measuring heads 1 and 21 during the measuring sequences, stores the measurement signals that are detected and processed in the measuring heads and generates the measurement results from them.

Initially, the following signals are detected for a combined measurement of reflection and transmission.

With the lamp switched off (or without flash, as the case may be), a dark measurement is carried out synchronously in the three spectrometers SP1, SP3 and SP1′ of both measuring heads 1 and 21. It can be carried out as often as desired (in principle, before every bright measurement) for continuous updating:

S_{D1}; S_{D1′}; S_{D3}.

With the lamp switched on (or during the flash as the case may be) in the reflection measuring head and without specimen (air), a bright measurement is carried out synchronously in the three spectrometers of both measuring heads:

S_{H1}; S_{H1′}; S_{H3}.

With the lamp switched on and the white standard introduced, another bright measurement is carried out synchronously with the two spectrometers SP1 and SP3 of the reflection measuring head:

S_{W1}; S_{W3}.

With special method requirements, a bright measurement is carried out synchronously with the two spectrometers of the reflection measuring head with the lamp switched on and black standard introduced:

S_{S1}; S_{S3}.

Finally, with the lamp switched on and measurement specimen introduced, a synchronous bright measurement is carried out in the three spectrometers of both measuring heads:

S_{P1}; S_{P1}′; S_{P3}.

The measurement results are then reached as follows:

First, a dark correction is performed again by subtracting from the spectral signals of the bright measurement and the dark measurement of the respective spectrometer which immediately preceded it. An exact correction is ensured when every bright measurement is immediately preceded by a dark measurement with the same specimen (air, white, black, measurement). This ensures that the dark signals will be as current as possible:

S_{koor,i}=Sᵢ=S_{Di}

(i stands for different specimens and spectrometers).

The dark-corrected measurement signals in both measuring heads when measuring without a specimen (air) are standardized on the dark-corrected compensation signal (quotient formation). The standardized signals generally do not contain any additional intensity fluctuations of the lamp and compensate during reflection measurement for inevitable systematic sphere errors. The standardized signal of the transmission measurement continues to be used as a reference signal (100% T) for the following transmission specimen measurements. The standardized signal in the reflection measurement can be used in the Following as black reference signal (0% R).

$${Q}_{H1} = \frac{{S}_{korrH1}}{{S}_{korrH3}} ; {Q}_{H3} = \frac{{S}_{korrH1′}}{{S}_{korrH3}}$$

The dark-corrected measurement signal of the reflection measuring head when measuring with white standard is standardized on the associated dark-corrected compensation signal. The standardized signal for the reflection measurement is further used as white reference signal (100% R):

$${Q}_{W} = \frac{{S}_{korrW1}}{{S}_{korrW3}}$$

With special method requirements, the dark-corrected measurement signal can be standardized on the associated dark-corrected compensation signal during measurement with black standard and can be used for reflection measurement as special black reference signal (0% R).

$${Q}_{S} = \frac{{S}_{korrS1}}{{S}_{korrS3}}$$

The dark-corrected measurement signals in the two measuring heads in the case of specimen measurement are standardized on the dark-corrected compensation signal. The standardized signal of the transmission measurement is referred to the stored reference signal (100% T). The quotient shows the transmission factor of the specimen in relation to air. The standardized signal of the reflection measurement is reduced by the black reference signal (subtraction) and referred to the difference between the stored white reference signal and black reference signal. The quotient shows the reflection factor of the specimen related to the white standard and black standard employed:

$${Q}_{P1} = \frac{{S}_{korrP1}}{{S}_{korrP3}} ; {Q}_{P1′} = \frac{{S}_{korrP1′}}{{S}_{korrP3}}$$

$$T = \frac{{Q}_{{P1}^{′}}}{{Q}_{{H2}^{′}}} ; R = \frac{{Q}_{P1} - {Q}_{H1}}{{Q}_{W} - {Q}_{H1}} \text{or} R = \frac{{Q}_{P1} - {Q}_{S}}{{Q}_{W} - {Q}_{S}}$$

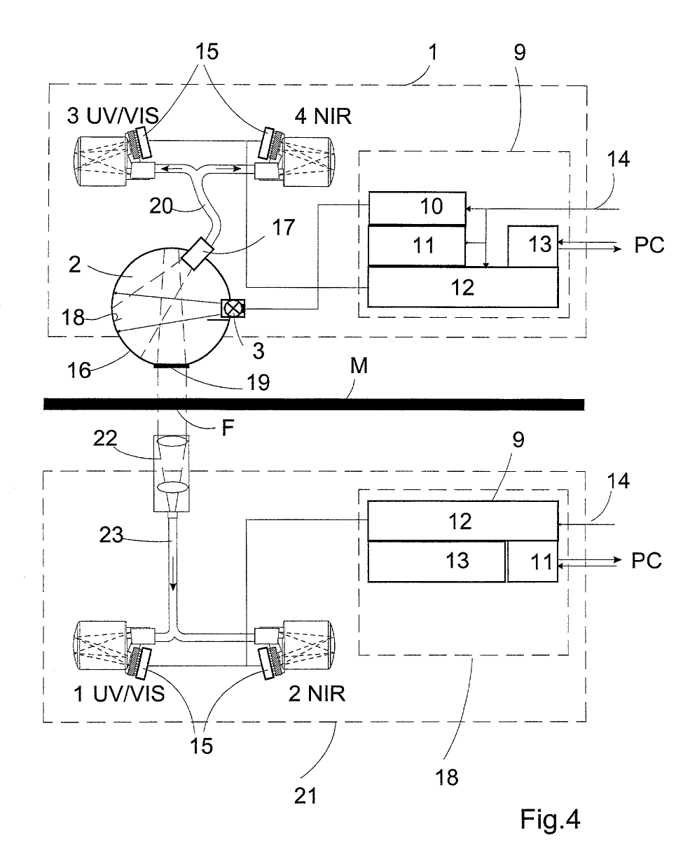

The fourth embodiment example in FIG. 4 shows a spectroscopic measuring arrangement for transmission measurement in which a compensation signal is obtained. It comprises two measuring heads 1 and 21 which are arranged on either side of a measurement object M. The illumination part, including the component for the compensation measurement, is accommodated in a first measuring head, while the second measuring head 21 has the component for measurement light detection and analysis. The two measuring heads 1 and 21 are aligned with one another in a stationary frame or are arranged in a double-crosspiece which is movable transversely.

The first measuring head 1 essentially corresponds to the first measuring head of the second embodiment example, wherein the spectrometers SP1 and SP2 required for reflection measurement and the associated measurement light receiver 6 are dispensed with.

Consequently, the photometric sphere 16 provided at the first measuring head 1 comprises only one measurement light source 3 and a reception device 17 which is directed to a reference surface 18 at the inner surface of the photometric sphere. The detected light of the reference surface 18 is faded into two spectrometers SP3 and SP4 via a short Y-light guide 20, wherein the former covers the UV range and the range of visible light, while the latter covers the near infrared range. Further, an electronics unit 9 with a signal processing device 12, an interface 13, and a stabilizing voltage supply (10) of the measurement light source 3 which is managed by a microprocessor are provided in the first measuring head 1.

The detection of the actual measurement light which is radiated through the opening 19 of the photometric sphere 16 on the measurement light spot F is carried out by means of a measurement light receiver 22 arranged at the second measuring head 21 coaxial to the opening 19. The measurement light detected by the latter is coupled into two spectrometers SP1 and SP2 simultaneously via a light-conducting device 23 in the form of a short Y-light guide; the spectrometers SP1 and SP2 are again constructed as miniature spectrometers with diode line receivers 15. The first spectrometer SP1 covers the same frequency range as the associated spectrometer SP3 in the first measuring head 1. The same is true for the second spectrometer SP2 in relation to the spectrometer SP4 arranged in the first measuring head 1.

The electronics unit 9 provided in the second measuring head 21 performs the signal processing in this instance and communicates with an external computer and/or an external display device; the signal processing and the external communication are controlled by the microprocessor 11. The two electronics units 9 are matched via the external computer.

The signal is obtained in the following manner:

With the lamp switched off, a dark measurement is carried out synchronously in two spectrometers SP1 and SP2 and in the two spectrometers SP3 and SP4:

S_{D1}; S_{D2}; S_{D3}; S_{D4}.

With the lamp switched on, a bright measurement is carried out synchronously in all four spectrometers in air (without specimen) or with a predetermined reference specimen, depending on the requirements of the method:

S_{H1}; S_{H2}; S_{H3}; S_{H4}.

With the lamp switched on and measurement specimen introduced, another bright measurement is carried out synchronously in all four spectrometers:

S_{P1}; S_{P2}; S_{P3}; S_{P4}.

The measurement results are then reached as follows:

First, a dark correction is carried out by subtraction from the spectral signals of the bright measurement and the dark measurement which precedes it as closely as possible for each spectrometer, wherein the same specimen is introduced with both measurements:

S_{korr,i}=Sᵢ−S_{Di}.

The index i describes the number of the spectrometer as well as the common specimen type (H, P).

The dark-corrected measurement signals of spectrometer SP1 are standardized on the dark-corrected compensation signals of spectrometer SP3 and those of spectrometer SP2 are standardized on those of spectrometer SP4. The signals of a common specimen type are considered:

$${Q}_{P1} = \frac{{S}_{korr , P1}}{{S}_{korr , P3}} ; {Q}_{P2} = \frac{{S}_{korr , P2}}{{S}_{korr , P4}} ; {Q}_{H1} = \frac{{S}_{korr , H1}}{{S}_{korr , H3}} ; {Q}_{H2} = \frac{{S}_{korr , H2}}{{S}_{korr , H4}}$$

Finally, the transmission factor of the specimen is calculated for the partial areas from the quotients of the spectrometers associated with each spectral partial area:

$${T}_{1} = \frac{{Q}_{P1}}{{Q}_{H1}} ; {T}_{2} = \frac{{Q}_{P2}}{{Q}_{H2}}$$

While the foregoing description and drawings represent the present invention, it will be obvious to those skilled in the art that various changes may be made therein without departing from the true spirit and scope of the present invention.

What is claimed is:

1. An optical measuring arrangement for determining properties of measurement objects, particularly for quality control of measurement objects flowing and/or moving past the measuring arrangement continuously, comprising:
a measuring head which is positioned in a defined position relative to the measurement object;
a measurement light source which is connected with the measuring head for illuminating a measurement spot on the measurement object;
a measurement light receiver provided in the measuring head for detecting light from the area of the measurement spot;
at least one spectrometer which is optically coupled with the measurement light receiver and integrated in the measuring head; and
a signal processing device which is likewise received in the measuring head for processing the output signals of the at least one spectrometer.

2. The optical measuring arrangement according to claim 1, wherein the measuring head contains two spectrometers which are constructed for adjoining wavelength ranges so that preferably wavelengths from 350 nm to 2500 nm can be continuously evaluated and both spectrometers cooperate with the same measurement light receiver and are optically coupled with the latter via a Y-light guide.

3. The optical measuring arrangement according to claim 1, wherein an interface to an external computer and/or to an external display device is provided at the measuring head.

4. The optical measuring arrangement according to claim 1, wherein a photometric sphere with an opening directed to the measurement spot is provided in the measuring head, wherein measurement light source and measurement light receiver are connected with the photometric sphere in such a way that the measurement light is directed indirectly through the opening onto the measurement spot and the light proceeding from the measurement spot is directed directly onto the reception surface of the measurement light receiver.

5. The optical measuring arrangement according to claim 1, wherein for every existing spectrometer there is associated, in addition, a second spectrometer which is identical with respect to measuring range, wherein the additional spectrometers are provided for the evaluation of the light coming from a reference surface.

6. The optical measuring arrangement according to claim 5, wherein the reference surface is located at an inner wall portion of the photometric sphere and the additional spectrometers are optically coupled with a reception device via a Y-light guide.

7. The optical measuring arrangement according to claim 1, wherein by a second measuring head which is positioned in a defined position in relation to the measurement object, wherein the first measuring head and second measuring head are located diametrically opposite to one another in relation to the measurement spot, and the second measuring head is provided with a second measurement light receiver for receiving the light transmitted in the area of the measurement spot from the measurement object; at least one additional spectrometer which is optically coupled with the measurement light receiver via a light-conducting device; and a signal processing device likewise integrated in the second measuring head for processing the signals put out by the additional spectrometer.

8. The optical measuring arrangement according to claim 7, wherein two spectrometers which are built for adjoining wavelength regions are received in the second measuring head, so that preferably wavelengths from 350 nm to 2500 nm can be continuously evaluated, and wherein both spectrometers cooperate with the same measurement light receiver and are optically coupled therewith via a light-conducting device.

9. The optical measuring arrangement according to claim 7, wherein a data interface to an external computer and/or to an external display device is provided at the second measuring head.

10. The optical measuring arrangement according to claim 7, wherein the output signals of the additional spectrometer in the first measuring head are combined for purposes of signal compensation with the signals of the additional spectrometer located in the second measuring head.

11. An optical measuring arrangement for determining properties of measurement objects, particularly for quality control of measurement objects flowing and/or moving past the measuring arrangement continuously, comprising:
a first measuring head which is positioned in a defined position relative to the measurement object;
a measurement light source which is connected with the first measuring head for illuminating a measurement spot on the measurement object;
a second measuring head which is positioned in a defined position in relation to the measurement object and which is located diametrically opposite to the first measuring head in relation to the measurement spot;
a measurement light receiver provided at the second measuring head for detecting light in the area of the measurement spot;
at least one spectrometer which is optically coupled with the measurement light receiver and integrated in the second measuring head; and
a signal processing device which is likewise integrated in the second measuring head for processing the output signals of the at least one spectrometer.

12. An optical measuring arrangement according to claim 11, wherein two spectrometers which are built for adjoining wavelength regions are received in the second measuring head, so that preferably wavelengths from 350 nm to 2500 nm can be continuously evaluated, and wherein both spectrometers cooperate with the same measurement light receiver and are optically coupled therewith via a light-conducting device.

13. The optical measuring arrangement according to claim 11, wherein for every spectrometer in the second measuring head there is, in addition, a second, identical spectrometer provided in the first measuring head, wherein the additional spectrometers are provided for evaluating the light coming from a reference surface.

14. The optical measuring arrangement according to claim 11, wherein a photometric sphere with an opening directed on the measurement spot is provided in the measuring head, wherein the measurement light source and measurement light receiver are connected with the photometric sphere in such a way that the measurement light is directed to the measurement spot indirectly through the opening, and in that a reception device is provided at the photometric sphere and is optically coupled with the spectrometers via a Y-light guide, and the reference surface is located at an inner wall portion of the photometric sphere.

15. The optical measuring arrangement according to claim 11, wherein an interface to an external computer and/or an external display device is provided at each of the two measuring heads.

16. The optical measuring arrangement according to claim 1, wherein the light-conducting devices are formed of light-conducting fibers.

17. The optical measuring arrangement according to claim 1, wherein the spectrometers are constructed as miniature spectrometers with diode line receivers.

18. The optical measuring arrangement according to claim 1, wherein the measurement light source can be switched on and off.
Reference Numbers
1 measuring head
2 measuring unit
3 measurement light source
4 condenser lens, lens
5 protective glass
6 measurement light receiver
7 Y-light guide
8 Y-light guide
9 electronics unit
10 voltage supply
11 microprocessor
12 signal processing device
13 interface
14 current supply
15 diode line receiver
16 photometric sphere
17 reception device
18 reference surface
19 opening
20 Y-light guide
21 measuring head
22 measurement light receiver
M measurement object
F measurement spot
SP1, SP2 spectrometer
SP3, SP4 spectrometer
